(19) United States
(12) Patent Application Publication
(10) Pub. No.: US 2021/0379842 A1
(43) Pub. Date: Dec. 9, 2021

(54) ROTOR BLADE WITH BELTS COMPRISING PULTRUDED PRODUCTS

(71) Applicant: SIEMENS GAMESA RENEWABLE ENERGY SERVICE GMBH, Hamburg (DE)

(72) Inventor: ROBERT SCHIRNER, Rendsburg (DE)

(21) Appl. No.: 17/298,423

(22) PCT Filed: Nov. 26, 2019
(86) PCT No.: PCT/EP2019/082584

§ 371 Date: May 28, 2021

(30) Foreign Application Priority Data
Nov. 28, 2018 (DE) 10 2018 009 332.9

(51) Int. Cl. B29C 70/34; B29C 70/44; B29D 99/00; F03D 1/06

(52) U.S. Cl. CPC B29C 70/342; B29C 70/44; B29L 2031/085; F03D 1/0675; B29D 99/0028

(57) ABSTRACT

A method for producing a component of a rotor blade, by providing a production mould (2) with a curved support surface (1), at least one flexible pultrudate (4) being laid onto the support surface (1), the at least one flexible pultrudate (4) being covered with a vacuum film (6), a vacuum being generated and the at least one flexible pultrudate (4) being pressed entirely onto the curved support surface (1) of the production mould (2) by the vacuum.

The invention relates to a method of producing a component of a rotor blade. The invention also relates to an arrangement for producing a component of a rotor blade.

Naturally, methods for producing components of rotor blades are well known in the prior art. Rotor blades are usually assembled from a plurality of components. Rotor blades have for example two rotor blade half-shells, and a girder runs in the longitudinal direction along each of the rotor blade half-shells. The girders are arranged opposite one another in the interior of the rotor blade and are connected to a web. The rotor blade half-shells are adhered to one another at their edges. In addition, there are also other designs of rotor blades.

The girders, as components of the rotor blades, can be produced beforehand in separate production moulds. The girders are produced in a known manner from pultrudates. Pultrudates are continuous pultruded strips which have glass fibre rovings and/or carbon fibre rovings running in the longitudinal direction. The rovings are connected to one another by a cured resin system. The girders are produced from a number of pultrudates. For this purpose the pultrudates are laid alongside one another and one above the other into the production mould for the girder. The pultrudates are relatively rigid, both in cross-section and also in longitudinal section i.e. they are not flexible or only flexible with difficulty. This leads to the problem that the pultrudates laid alongside one another on a curved support surface of the production mould do not rest entirely on the support surface, but only rest at their edges on the concavely curved support surface.

The pultrudates laid alongside one another are then covered with a vacuum film which is sealed on the edges of the production mould. Then between the support surface and the vacuum film a vacuum is generated, which draws the vacuum film onto the support surface and in this case exerts a force on the pultrudates so that they are bent somewhat towards the support surface.

However, it has been shown that the atmospheric pressure acting on the pultrudates is not sufficient, even with the vacuum, to press the pultrudates entirely onto the support surface of the production mould. In fact empty spaces remain between the support surface and the underside of the pultrudates. During the ensuing resin infusion process these empty spaces are filled with resin, and in the ensuing curing process the resin cures in the spaces. Although the girders are firmly adhered by the cured resin and the pultrudates are firmly adhered to one another, the spaces which are filled with resin have a significantly lower tensile strength than the spaces which are filled with pultrudates, in particular since the resin-filled spaces do not comprise any fibres running in the longitudinal direction.

Furthermore, it has been shown that in several infusion processes, the force exerted by the vacuum on the inflexible pultrudates is not sufficient to press the pultrudates against the support surface, as the pultrudates have an insufficient flexibility in order to be pressed against the support surface. Disadvantageously, however, the pultrudates can break before they entirely contact the support surface.

Both the breaking of the pultrudates and also the emergence of resin-filled spaces is naturally disadvantageous for the strength of the girder.

Therefore in a first aspect it is an object of the invention to further develop a production process which is referred to in the introduction, so that the above-mentioned disadvantages are reduced, and preferably no longer occur at all.

Therefore in a second aspect it is an object of the present invention to further develop an arrangement which is referred to in the introduction for producing a component of a rotor blade, so that the above-mentioned disadvantages are reduced, and preferably no longer occur at all.

In its first aspect, the object is achieved by a production method referred to in the introduction with the features of claim 1.

According to the invention a production mould with a curved support surface is provided. A flexible pultrudate is laid on the curved support surface. The at least one pultrudate is covered with a vacuum film, and between the vacuum film and the support surface a vacuum is generated, so that the at least one pultrudate is drawn entirely onto the curved support surface of the production mould. This means that the at least one pultrudate rests with the entire underside on the support surface. If the pultrudate is not laid directly onto the support surface, but for example a further pultrudate layer is arranged between the at least one pultrudate and the support surface, “drawn entirely” means that it rests with its underside over the entire surface of the further pultrudate.

It is an essential feature of the invention, that the at least one pultrudate is not completely cured as it is laid onto the curved support surface and therefore is not inflexible, but is flexible, and in fact is flexible in such a way that it can be pressed onto the entire curved support surface without breaking. Furthermore, it is so flexible that the atmospheric pressure is sufficient to press the pultrudate entirely onto the curved support surface when the space between the pultrudate and the support surface is filled with an infusion vacuum.

Pultrudates are usually produced in a pultrusion process. For this purpose fibres are spread out alongside one another on rovings arranged on coils and are guided individually or in smaller bundles through a resin bath. A resin matrix is preformed, and the resin matrix is heated and thereby cured. Depending upon the duration and height of the temperature, the resin system cross-links less strongly or more strongly and as a result becomes more solid. As is known, the pultrudates are provided with a completely cured resin system.

Pultrudates are provided as rolled material and are cut into long portions of 30 m, 40 m or even longer. They have widths of approximately 100 mm to 3,000 mm and thicknesses of 5 mm to 20 mm. Naturally, however, other dimensions are also conceivable. The long pultrudates are straight in the transverse direction perpendicular to the longitudinal direction, and are preferably straight in every cross-section. In particular in cross-section the pultrudates can only be pressed onto the curved support surface with difficulty.

It is known from DE 10 2008 006 588 B4 that thermosetting cross-linked plastics, which are for example the resin systems mentioned here, are available in a partially cross-linked, gelled and infusible state. Furthermore, it is known that these inflexible and solid starting products can be adapted to a final shape, that is to say for example to the curved shape of the support surface, by being heated to above a glass transition temperature Tg and thereby transitioning from the solid state into a resilient, rubber-like state, which allows the thermosetting starting product to be reshaped into another, for instance curved, external shape. By later cooling to below the glass transition temperature Tg the reshaping is preserved. The plastics material is subsequently completely cured by cross-linking. Depending upon the degree of cross-linking, the glass transition temperature Tg is between −50° C. and +140° C., at degrees of cross-linking of over 70% at above 40° C.

According to the invention, however, the pultrudate is not heated to a temperature above the glass transition temperature Tg, but to a lower temperature below the glass transition temperature Tg. It also does not need any additional heating and can be at ambient temperature. It is then laid on the curved support surface. Because the pultrudates are sufficiently soft, without having to be heated again, they can adhere to the curved support surface under a slight pressure of the vacuum infusion.

Therefore it is preferably provided that the pultrudate is not additionally heated, but is left at a temperature which is below the glass transition temperature Tg, and at this temperature a vacuum is generated between the vacuum film and the support surface and the flexible pultrudate is drawn onto the support surface.

In a preferred further embodiment of the invention the resin-infused soft pultrudate is then cured in a conventional curing process together with the resin which surrounds the pultrudate. For this purpose the pultrudate is heated continuously for a predetermined time period.

The at least one pultrudate is advantageously curved along a cross-section and along a longitudinal section in a girder production form. Girders usually consist for instance of three to five pultrudates lying alongside one another and up to ten pultruded layers arranged one above the other. Each pultrudate is curved transversely and longitudinally during the girder production. Thus the girder the which is made up of a number of pultrudates is also curved along a cross-section and along a longitudinal section, and also the girder lies entirely on the support surface of the girder production mould. Because the girder optimally takes up the curvature in the cross-section and the longitudinal section, it can be laid with a precise fit onto the rotor blade half-shell.

In principle it is conceivable that the girder is not completely cured after the infusion process but, like the pultrudates which serve for production of the girder, is only cured to such an extent that it retains its shape for transport but nevertheless remains soft, and in this state it can be laid into the rotor blade half-shell. The stack of layers which serves for formation of the rotor blade half-shell, and also the girder which is not yet cured and is laid onto the stack of layers, are then infused with resin in a separate infusion process and laminated together and are heated in a final heating step to a sufficiently high temperature and for a sufficient time until the entire resin system both in the pultrudates and also in the girder as well as the resin system between the girder and the rotor blade half-shell is completely cured.

In a second aspect the object is achieved by an arrangement referred to in the introduction and having the features of claim 5.

The arrangement comprises and serves for producing a component of a rotor blade. It comprises a production mould with a curved support surface and at least one pultrudate which is not cured and lies on the curved support surface. As described above, the pultrudate is only cured to such an extent that it can be pressed entirely onto the curved support surface under normal air pressure.

The pultrudate has a glass transition temperature Tg. However, it is not heated to a temperature above the glass transition temperature Tg. Rather, the at least one pultrudate, after it is made available and laid onto the support surface of the production mould and also while the vacuum is produced, is not heated to a temperature above the glass transition temperature Tg.

The arrangement preferably comprises a vacuum film which is drawn over the at least one uncured pultrudate, and the at least one pultrudate lies entirely on the support surface. This arrangement is an arrangement which is produced during the production of a girder of a rotor blade. In this case the pultrudate is at a temperature which is below the glass transition temperature Tg, and it is not cured.

The invention is described with reference to an exemplary embodiment in three drawings, in which:

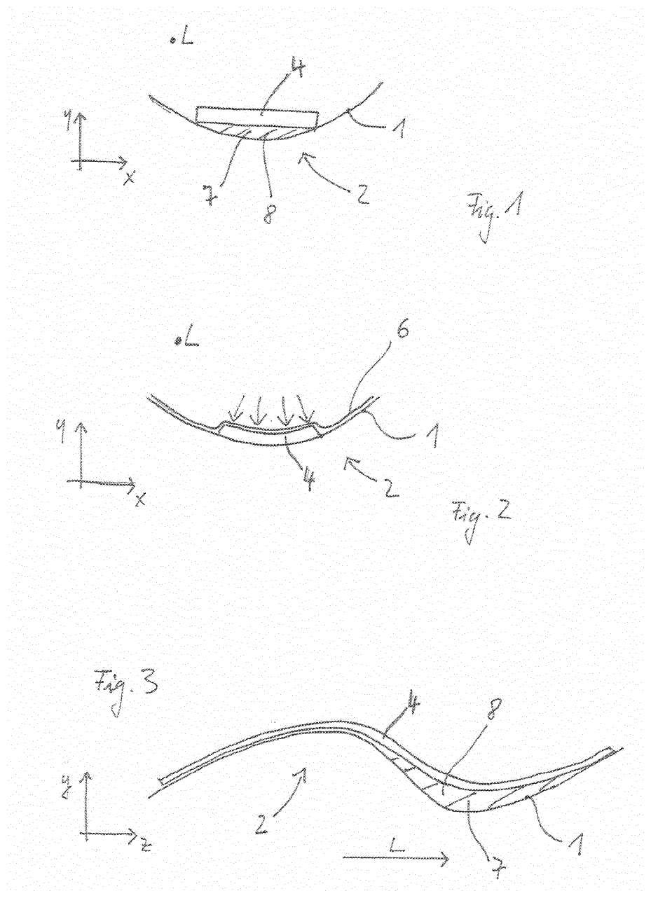

FIG. 1 shows a cross-sectional view of a flat pultrudate laid onto a curved support surface of a production mould,

FIG. 2 shows a cross-sectional view of a pultrudate drawn onto the curved surface of the production mould,

FIG. 3 shows a longitudinal section of a pultrudate laid on the curved surface before the drawing on.

A curved support surface 1 of a production mould 2 for a girder of a rotor blade is shown in FIG. 1 in a cross-section perpendicular to a longitudinal direction L.

The girders according to the invention have a number of pultrudates 4 which can be arranged in the longitudinal direction alongside one another and one above the other. The cross-section of a pultrudate 4 for producing the girder is shown in FIG. 1. A girder cross-section would comprise a number of pultrudates 4, for example three to five pultrudates 4 laid alongside one another and up to ten laid one above the other.

The production mould 2 illustrated in FIG. 1 serves for the separate production of girders. The girders are finished separately as components of a rotor blade and then laid as a finished component onto an inner wall of a rotor blade half-shell. The rotor blade half-shell is not yet laminated as a finished component but, at the time at which the finished girder is laid onto it, comprises a stack of woven and laid fabric layers including sandwich core materials, balsa wood or the like. The laminated girder is laid onto the stack of layers and is laminated into the rotor blade half-shell in a subsequent lamination process.

Since the rotor blade shell is curved both in cross-section and also in longitudinal section along the support surface of the pultrudate 4, the pultrudate 4 must already incorporate the curvatures in its own shape in order to lie as entirely as possible, at least over a large area on the inner wall of the rotor blade half-shell. Therefore the support surfaces 1 of the production mould 2 of the girder which are illustrated in FIG. 1 and also in FIG. 3 are curved both in cross-section and also in longitudinal section. The illustrated curvature is not true to scale, but is illustrated exaggeratedly.

Pultrudates 4 are usually produced in a pultrusion process. For this purpose rovings, which are carbon fibre and/or glass fibre bundles stored on coils, are unrolled alongside one another and one above the other and are drawn alongside one another in the longitudinal direction through a resin bath or surrounded by a liquid resin, which is then heated together with the rovings in a furnace. During the heating the resin cures, and a solid pultrudate 4 is produced which is flexible with difficulty. However, the pultrudates according to the invention are more easily flexible by comparison with the conventional pultrudates. For this purpose, during the process of producing the pultrudate 4, first of all in a conventional manner rovings are unwound from coils, arranged alongside one another and covered with liquid resin. The rovings with the resin are moved through a furnace, wherein, however, the residence time and/or the temperature of the furnace are shortened or lowered respectively by comparison with the conventional curing step, so that the resulting pultrudate is not completely cured. Because the complete pultrudate is not completely cured, thus it is more flexible and softer, it can be used for the production method according to the invention.

FIG. 1 shows the unbent conventional pultrudate 4, which is laid onto the curved support surface 1 of the production mould 2. For the production of a girder a plurality of pultrudates 4 are usually laid alongside one another and one above the other. The problem which arises in this case is illustrated in principle in FIG. 1, that is to say that in specific regions, in this case between the support surface 1 and an underside of the pultrudates 4, a space 7 is formed in which resin 8 collects during an infusion process. After the curing operation at the end of the infusion process a solid girder is indeed produced, but along the space 7 it includes a considerable amount of resin 8 which does not have the tensile strength of the pultrudates 4 as it has no fibre structure. Therefore it is preferably provided that a girder is produced which has the fewest possible spaces 7 filled with resin 8 and consists predominantly of a homogeneous pultrudate structure with fibres running in the longitudinal direction.

According to the invention the incompletely cured pultrudates 4 according to FIG. 2 are laid onto the support surface 1 of the production mould 2 and the dry construction of the girder is covered with a vacuum film 6 in a conventional manner. The vacuum film 6 is sealed at its edges, and a vacuum is generated between the vacuum film 6 and the support surface 1. Due to the generated vacuum the surrounding air pressure presses the pultrudates 4 against the support surface 1 of the production mould 2. Since the pultrudate 4 is not completely cured, but is soft, the pultrudate 4 according to FIG. 2 adheres to the support surface 1, i. e. it forms a contact with the support surface over the entire underside facing the support surface 1.

The production mould 2 can be heated during the infusion process, so that as a result an additional softening of the pultrudate 4 is possible.

After the vacuum is produced or simultaneously, resin 8 is infused into the pultrudate structure and the pultrudates 4 are adhered to one another. During subsequent heating the resin 8 is completely cured, and a girder is produced for a rotor blade half-shell, wherein the pultrudates 4 of the girder are optimally adapted to the curvature of the support surface 1 and nevertheless no internal tension is built up in the pultrudates 4 during the infusion process, since the soft pultrudates 4 can curve easily, i.e. without a great application of force against the support surface 1 and no tension or opposing force has to be overcome.

A longitudinal section through the production mould of FIG. 1 and FIG. 2 is shown in FIG. 3. In the longitudinal direction L the pultrudate 4 also conventionally has portions which do not lie entirely on the support surface 1 of the production mould 2 and therefore form the spaces 7 in which resin 8 can collect below the pultrudate 4. In order to avoid the spaces 7, the pultrudates 4 according to the invention which are not completely cured are used as mentioned above, and during the vacuum infusion process the pultrudate 4 in longitudinal section is also drawn entirely onto the support surface 1 due to the generation of the vacuum, so that during the subsequent resin infusion process no spaces 7 are formed which fill with resin 8. After the infusion process and the curing, in the longitudinal direction L the laminated girder is also built up homogeneously of pultrudates 4 which are merely adhered to one another by the resin 8. The girder is advantageously completely cured and then, with its curvature formed in cross-section and in longitudinal section, it is laid into the rotor blade half-shell with full contact.

It is also conceivable that the entire girder is not completely cured, that is to say during the infusion process, by comparison with conventional infusion processes, the temperature of the production mould 2 is raised for a shorter time and/or to a lower curing temperature, so that after the infusion process the girder is not completely cured, but remains soft and, in an analogous manner to the above-mentioned pultrudate 4, is laid into the rotor blade half-shell where in an infusion process it is drawn onto the support surface 1 of the rotor blade half-shell.

### LIST OF REFERENCE NUMERALS

1 support surface
2 production mould
4 pultrudates
6 vacuum film
7 space
8 resin
L longitudinal direction
Tg glass transition temperature

1. A method for producing a component of a rotor blade, by providing a production mould (2) with a curved support surface (1), at least one flexible pultrudate (4) being laid onto the support surface (1), the at least one flexible pultrudate (4) being covered with a vacuum film (6), a vacuum being generated and the at least one flexible pultrudate (4) being pressed entirely onto the curved support surface (1) of the production mould (2) by the vacuum.

2. The method according to claim 1, characterised in that if the at least one flexible pultrudate (4) is initially straight in a cross-section and while it is pressed by the formation of the vacuum onto the curved support surface (1), it is kept continuously at a temperature below the glass transition temperature (Tg).

3. The method according to claim 1, characterised in that the component is infused with resin (8) and the resin (8) and the at least one pultrudate (4) are cured.

4. The method according to claim 1, characterised in that the at least one pultrudate (4) is curved along a cross-section and along a longitudinal section.

5. The method according to claim 1, characterised in that the at least one pultrudate (4) is heated to a temperature below a glass transition temperature (Tg) and at that temperature is pressed onto the curved support surface (1).

6. The method according to claim 1, characterised in that two to five pultrudates (4) are laid alongside one another and up to ten pultrudates (4) are laid one above the other on the curved support surface (1) and an infusion process is carried out and a girder is produced.

7. Arrangement for producing a component of a rotor blade with a production mould (2) having a curved support surface (1) and at least one flexible pultrudate (4) which lies entirely on the support surface (1) and has a glass transition temperature (Tg) and is at a temperature below the glass transition temperature (Tg).

8. Arrangement according to claim 7, characterised in that a vacuum film (6) is laid over the at least one uncured pultrudate (4).
